(19) United States
(12) Patent Application Publication
(10) Pub. No.: US 2017/0372147 A1
(43) Pub. Date: Dec. 28, 2017

(54) AROUND VIEW MONITORING SYSTEM AND METHOD FOR VEHICLES

(71) Applicant: VOLVO CAR CORPORATION, Gothenburg (SE)

(72) Inventors: Per STERVIK, Ytterby (SE); Nenad LAZIC, Gothenburg (SE)

(73) Assignee: VOLVO CAR CORPORATION, Gothenburg (SE)

(21) Appl. No.: 15/624,835

(22) Filed: Jun. 16, 2017

(30) Foreign Application Priority Data
Jun. 27, 2016 (EP) 16176408.9

(51) Int. Cl. G06K 9/00; G06K 9/20; B60R 1/00

(52) U.S. Cl. CPC G06K 9/00791; B60R 1/00; G06K 9/209; B60R 2300/105; B60R 2300/303; B60R 2300/806; B60R 2300/607

(57) ABSTRACT

The present disclosure relates to a method for illustrating the ground underneath a vehicle using an around view monitoring system. The around view monitoring system comprises at least one camera, a processing unit and a display unit. The method comprises taking at least one image on the ground using at least one camera, tracking the position of the ground with respect to the vehicle and visualizing the ground as an under vehicle view and as a function of the vehicle speed, if the vehicle is moved over at least a portion of the ground. An around monitoring system is also provided.

### CROSS-REFERENCE TO RELATED APPLICATIONS

This application claims foreign priority benefits under 35 U.S.C. §119(a)-(d) to European patent application number EP 16176408.9, filed Jun. 27, 2016, which is incorporated by reference in its entirety.

### TECHNICAL FIELD

The present disclosure relates to a method for illustrating the ground underneath a vehicle using an around view monitoring system, and an around view monitoring system for a vehicle. The method and the around view monitoring system is adapted to provide a driver with an under vehicle view by using e.g., the front, rear or side cameras.

### BACKGROUND

Around view monitoring systems are commonly used to monitor the surroundings of a vehicle. Monitoring the surroundings of vehicles have become more and more important not only from a safety perspective e.g., when parking but also when providing vehicles with added functions. Added functions could be lane detection just as a matter of example. Vehicles are thus provided with cameras positioned at different locations around the vehicle in order to get a full view around the vehicle.

Around view monitoring systems may project the captured images around a bird eye view of the vehicle in order to provide the driver with the sense of viewing the vehicle from above. This has been found to be extra useful when backing or parking.

The US patent application No. US 2016/0101734 A1 discloses an under vehicle image provision apparatus. The apparatus comprises a plurality of bottom view cameras mounted to a bottom of a vehicle. The bottom view cameras provides for under vehicle images from which a driver may view e.g., the tires of the vehicle. The proposed solution has some drawbacks however. Firstly; cameras positioned underneath the vehicle are most likely to be subjected to dirt, rubble and even water spraying from the tires when driving. Not to mention from dirt, rubble or water from other vehicles. There is a high risk that the camera lens will be covered, or even damaged, from being so close to the road. Secondly; the disclosed apparatus requires a several additional cameras in order to get a full view of the underside of the vehicle.

It appears that the present systems are relatively vulnerable and unnecessarily expensive.

### SUMMARY

It is an object of the present disclosure to remove or at least reduce the drawbacks mentioned above, or to provide for a useful alternative. At least one object is at least partly met by a method for illustrating the ground underneath a vehicle and an around view monitoring system for a vehicle. The around view monitoring system comprises at least one camera, a processing unit and a display unit. The method comprises taking at least one image on the ground using at least one camera. Tracking the position of the ground with respect to the vehicle; and visualizing the ground as an under vehicle view and as a function of the vehicle speed, if the vehicle is moved over at least a portion of the ground.

The method provides an easy and cheap way to provide for an under vehicle view without actually having under vehicle cameras. The method and system is very useful when positioning a vehicle with respect to an object on the ground underneath the vehicle e.g., when parking. Such object may be a charge station, a vehicle hoist, a vehicle maintenance pit just as a matter of example. The vehicle can be an automobile, a recreational van, a lorry, a bus, a boat, a trailer for example. The vehicle is preferably a land driven vehicle such as an automobile.

According to an aspect, the method may comprise the step of providing a live stream from at least one camera. The image may advantageously be combined with a live stream from a camera. In this way, the driver is provided with a view that combines an image taken a few moments ago with a live stream from a camera.

The at least one image may be stitched with a live stream feed from the at least one camera. In this manner, a driver driving the vehicle may be provided with a bird eye view for example of the vehicle, its surroundings and an under vehicle view at the same time. This may simplify the driving and positioning of the vehicle when parking.

The method may comprise the step of superposing the at least one image on an image representing the vehicle. This provides for a reference point for the driver and relates the contours of the vehicle with the captured images of the camera. Of course; the images may be adapted to correlate to the image representing the vehicle and/or the image representing the vehicle may be correlated to the other images. The image representing the vehicle is preferably a silhouette, a transparent picture, the contours or the like of the actual vehicle, or at least similar thereto.

The at least one image may be a still image, i.e., a snap shot, or a temporarily stored stream. The specific image type used may vary dependent on the desired functions. Sometimes it may be sufficient to have single still images continuously being updated and sometimes it may be desirable to have a high frame rate. A stream may be defined as having a frame rate of more than 20 frames per second.

The around view monitoring system may comprise one or more cameras, such as at least a front directed camera, a rear directed camera, a first and a second side camera. The first and the second cameras are preferably opposing side cameras i.e., left and right side cameras. One or more images taken by at least two of the cameras may be combined to form the at least one image, e.g., stitched. This is very useful when the vehicle turns and the vehicle drives over a portion of the ground at which two fields of view overlap, i.e., across the ground which may be overlapped by two cameras field of view.

The at least one image may be visualized as a function of vehicle speed and optionally one more vehicle parameter. When the vehicle moves, the at least one image may be moved on the displayed unit so as to illustrate, or replicate, the vehicle movement. Optionally, if the vehicle turns, the turn should be illustrated or replicated on the display unit by a similar displacement of the image. Other vehicle parameter may be travelled distance and/or steering angle for example. The travelled distance may be measured by the vehicle e.g., via wheel ticks, i.e., the number of laps the wheels has turned, or via GPS positioning, or other positioning units and methods. By this a driver can get a very good bird eye view when driving.

The vehicle defines a vehicle periphery on the ground when viewed from above. The at least one image is preferably taken on the ground outside of the vehicle periphery. The around view monitoring system does not need under vehicle cameras to form an under vehicle view. Instead, the driver just has to drive across the ground which has been imaged in order to display the image as an under vehicle view.

The at least one image is advantageously stitched with a live stream so as to form a stich seam following the vehicle periphery. By this a driver will get a very good driving assistance from the display unit.

The at least one image is visualized as a 3D image. The vehicle may be visualized from above to form a bird eye view, but the vehicle may optionally or additionally be visualized from the side. When visualized from the side, it may be advantageous if objects on the ground such as a charge station or a stone are visualized as 3D objects. The 3D image of objects may be created using 3D cameras, or two separate cameras imaging from two different positions.

The at least one image may be provided with a selected number of frames per second, the selected number of frames per second being set as a function of the vehicle speed. At a fast speed, the image may be provided at a high rate per second for example. The faster the vehicle travels, the more frames per second may be desirable.

It is also within the boundaries of the present disclosure to provide an around view monitoring system for a vehicle. The around view monitoring system comprises at least one camera, a processing unit and a display unit. The processing unit is adapted to track a ground area with respect to the vehicle based on the ground the at least one image is imaging and to visualize the at least one image as an under vehicle view if the vehicle is moved over at least a portion of the ground area.

The system provides a cheap system which does not require under vehicle cameras. Under vehicle cameras are often exposed to dirt, rubble, water and snow, especially from splashes from the tires. The present system removes the need for cameras positioned underneath the vehicle, or even at the underside of the vehicle, to provide the under vehicle view for a driver.

### BRIEF DESCRIPTION OF THE DRAWINGS

Non-limiting embodiments of the present disclosure will be described in greater detail with reference to the attached drawings.

FIG. 1 shows a vehicle having an around view monitoring system and with a view towards the side;

FIG. 2 shows the vehicle of FIG. 1 from above;

FIG. 3 shows the vehicle of FIG. 2 with the cameras field of view illustrated;

FIG. 4 shows a schematic block diagram of an around view monitoring system for a vehicle;

FIG. 5A shows a vehicle with the cameras field of view illustrated, FIG. 5A also illustrates an optional displayed view as displayed on a displaying unit;

FIG. 5B shows the vehicle of FIG. 5A with the front camera field of view illustrated, FIG. 5B also illustrates an optional displayed view as displayed on a displaying unit;

FIG. 6A shows the vehicle of FIG. 5A after the vehicle has been moved;

FIG. 6B shows the vehicle of FIG. 5B after the vehicle has been moved;

FIG. 7A shows the vehicle of FIG. 6A after the vehicle has been moved even further;

FIG. 7B shows the vehicle of FIG. 6B after the vehicle has been moved even further and;

FIG. 8 shows a schematic block diagram over an embodiment of a method for illustrating the ground underneath a vehicle.

### DETAILED DESCRIPTION

As required, detailed embodiments are disclosed herein. However, it is to be understood that the disclosed embodiments are merely exemplary and that various and alternative forms may be employed. The figures are not necessarily to scale. Some features may be exaggerated or minimized to show details of particular components. Therefore, specific structural and functional details disclosed herein are not to be interpreted as limiting, but merely as a representative basis for teaching one skilled in the art.

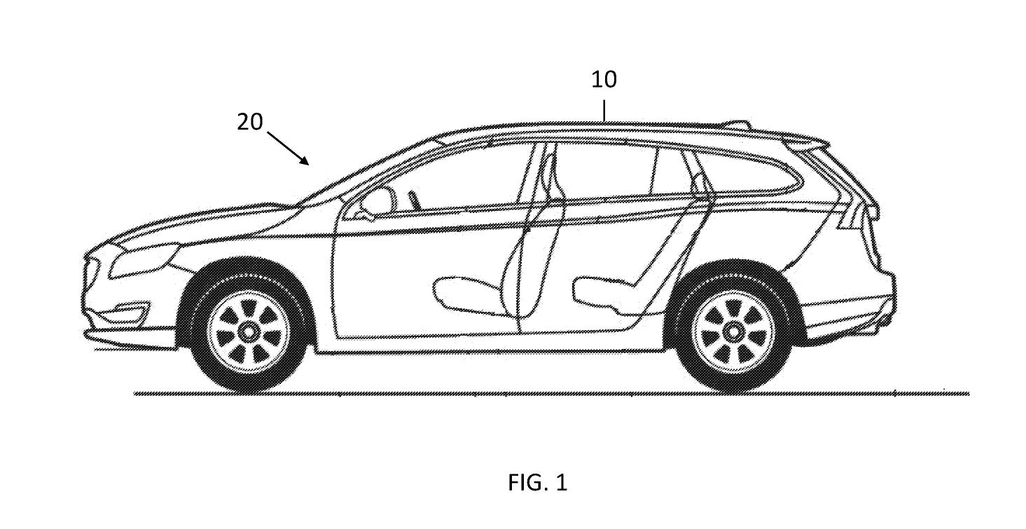

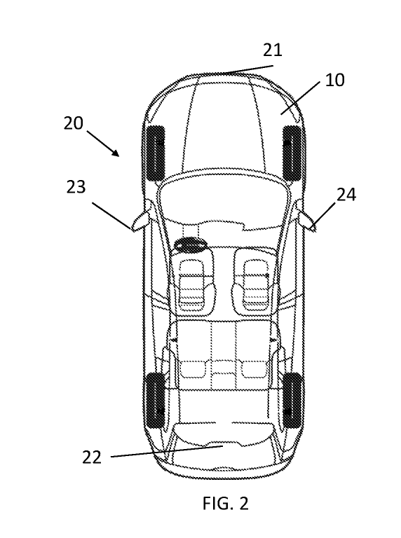

FIG. 1 shows a vehicle 10 in the form of an automobile with a view towards the side. The vehicle 10 comprises an around view monitoring system 20 having a plurality of cameras. Using the around view monitoring system, a driver may get a bird's eye view for example, assisting the driver when e.g., parking. FIG. 2 shows the vehicle 10 with a view from above. The around view monitoring system 20 has in the shown embodiment four cameras; a front camera 21, a rear camera 22 and first and second side cameras 23, 24 also referred to as left and right cameras 23, 24. It should be noted that the around view monitoring system 20 may be provided with one or more cameras and that the illustrated embodiment is shown with four cameras only for the purpose of simplicity. The around view monitoring system 20 may be provided with 1, 2, 3, 4, 5, 6, 7, 8, 9 or more cameras just as a matter of example. By use of the one or more cameras, it is possible to take an image and process that image e.g., by superposing the image on an image representing the vehicle. It is further possible to displaceably visualize the image as a function of the vehicle speed and/or one or more additional vehicle parameters. The position of the ground which has been imaged is tracked with respect to the vehicle. This will provide a virtual under vehicle image of the vehicle with a delayed time perspective giving the appearance of a vehicle driving across the ground. The image may further move synchronously with the vehicle to enhance the appearance of the vehicle driving over the ground.

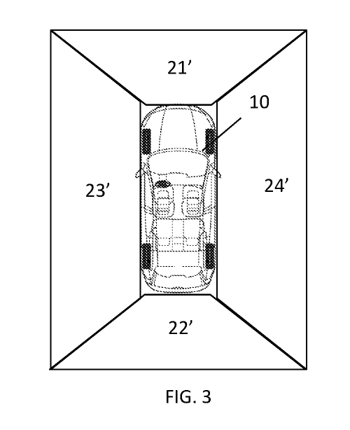

FIG. 3 shows the vehicle 10 with the front, rear, left and right cameras 21, 22, 23, 24 field of view illustrated 21′, 22′, 23′, 24′. The field of view further illustrates an around view image. When displayed to the driver in the vehicle 10 the around view image is usually illustrated with a top view of the vehicle 10 as shown in FIG. 3. The around view image may be live streamed to the display unit (not shown). As can be noticed, the field of view substantially follows the contours of the vehicle so that when displayed on the display unit, the live streamed film is correlated to the vehicle contours.

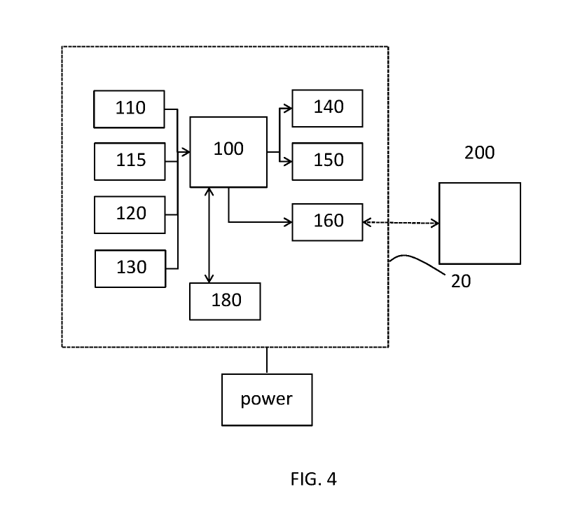

FIG. 4 schematically illustrates an embodiment of the around view monitoring system 20. The around view monitoring system 20 comprises a processing unit 100 which governs and processes data from the cooperating units, one or more cameras 110, one or more illumination units 115, other vehicle sensors 120, and a navigation unit 130. The around view monitoring system 20 further comprises a display unit 140, a data input unit 150, a communication unit 160, and a memory unit 180. A power supply such as the vehicle battery supplies power to the around view monitoring system. A server system 200 is available or updates or data processing and storage.

The processing unit 100 may be an on-board vehicle computer, CPU, or the like.

The one or more cameras 110 may be wide angle cameras, such as super wide angle camera, having an angle of view of 180 degrees or larger. The one or more cameras may of course be provided with light sensors. The one or more cameras may be provided with additional data collecting units such as radar, LIDAR, image recognition system, object detection unit, object identification unit, object tracking unit, or the like. The one or more illuminations units may be, light emitting diodes, such as infrared light-emitting diodes, to provide illumination to said cameras in low light conditions.

The vehicle sensors 120 may be any vehicle sensor such as strain gauges, speedometers, oil gauges, fuel gauges, steering angle sensors, dampening sensors, seat sensors, door sensors, light sensors, position and navigation sensor, accelerometers, heading sensor, yaw, sensor, gyro sensor, wheel sensor, vehicle body tilt sensor, battery sensor, tire sensor, inside and/or outside temperature sensor, interior humidity sensor, throttle sensor, crank sensor, water temperature sensor, air intake sensor, or the like.

The navigation unit 130 may be one or more GPS units, or enhanced GPS units, wi-fi positioning units, landmark navigational units or the like and combinations thereof.

The display unit 140 may be a fixed display unit of the vehicle such as a HUD, a LCD screen, or a mobile display unit such as mobile device, mobile phone, think pad, ipad or the like. It may be a touch screen or operated via buttons, voice commands, gesture recognition systems or the like. A data input unit 150 enable user to manipulate, change settings and/or operate the around view monitoring system 20. As can be understood, the display unit and the operating unit may be formed by the same device e.g., via a touch screen operated device.

The communication unit 160 may be adapted to communicate with a wireless network such as 3G, 4G, 5G telecom networks, wifi, bluetooth just to mention a few.

The memory unit 180 may be a data storage device and may store data captured by the cameras or other units. Camera data may be stored as in an mpeg format such as mpeg 1, 2, 3, or 4, AVI, M4V, 3GPP, 3GPP2, Nullsoft streaming video, jpeg or gif format just to mention a few data formats.

The server system 200 may be a cloud based administrated server, adapted to store or forward data. The data may be software updates, data processing or the like.

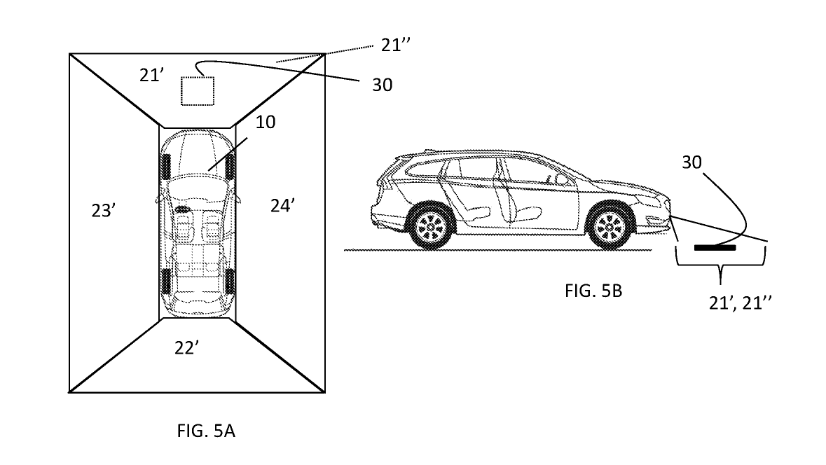

With reference to FIGS. 5A-7B, non-limiting embodiments of the method for illustrating the ground underneath a vehicle will be described in greater detail. FIGS. 5A, 6A, and 7A show the vehicle 10 with a view from above while FIGS. 5B, 6B, and 7B show the vehicle 10 with a view towards the side. The FIGS. 5A, 6A and 7A illustrate the vehicle 10 moving and thus show the vehicle 10 at different times and in a chronological order. In a similar manner, FIGS. 5B, 6B and 7B illustrate the vehicle 10 moving and thus show the vehicle 10 at different times and in a chronological order.

FIG. 5A shows the vehicle 10 and the field of view 21′, 22′, 23′, 24′, provided by the cameras. Just as a matter of example, the method will be described by using the front field of view 21′ and by illustrating the vehicle 10 driving straight ahead. For the purpose of describing the method, the display unit illustrates the vehicle 10 from above, in a similar manner as shown in FIG. 5A with live streams from the cameras 21, 22, 23, 24 showing the ground in respective fields of view 21′, 22′, 23′, 24′ on the display unit. FIG. 5B shows the front field of view 21′ from the side. As can be noticed the cameras of the around view monitoring system do not directly image the ground underneath the vehicle 10. Instead, the front camera (not shown) continuously takes images of the area in front of the vehicle 10, as is illustrated with the bracket representing the field of view 21′ as seen from the side while at the same time live streaming the area, i.e., the field of view 21′ to the display unit. The one or more images are stored, temporarily or permanently. The images may be stored locally or remotely on a server.

The other cameras, i.e., the rear camera 22, and the two side cameras 23, 24, may also take images if desirable. It should be noted that if the same camera is used to take one or more images also is live streaming, the one or more images may be retrieved from a temporarily stored live stream. The image does not necessarily need to be taken separately from a live stream. Hence it is possible to store the live streams, to retrieve an image therefrom of the ground which the vehicle drives over. The around view monitoring system 20 may temporarily store images of the surrounding environment from preferably all of the field of views 21′, 22′, 23′, 24′. To illustrate an object on the ground, a charge station 30 for an electrically powered vehicle is illustrated in FIG. 5A.

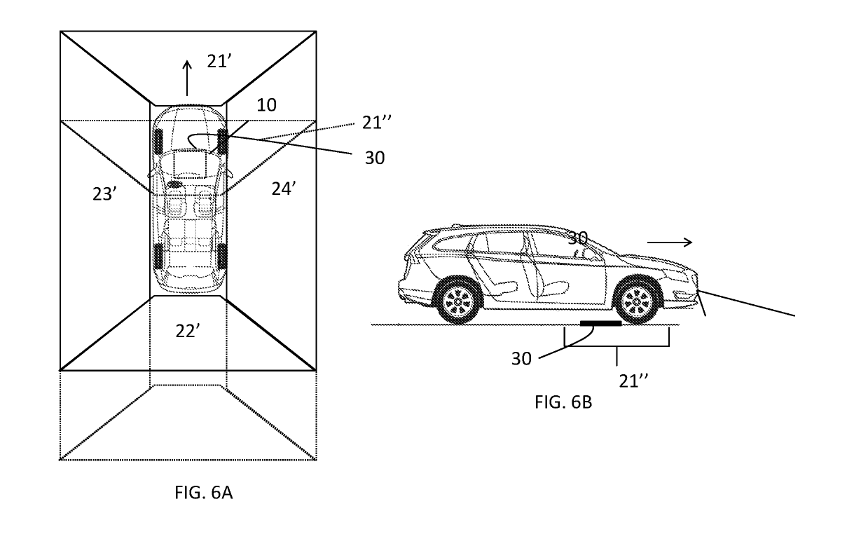

FIGS. 6A-6B show the vehicle 10 after travelling straight forward a limited distance. As can be seen the front camera 21 imaging an area represented by the field of view 21′, is still imaging in front the vehicle 10 to live stream that ground area to the driver. The image taken earlier by the front camera of the front field of view 21′, is imaging a ground area. The imaged ground area is referred to as ground area 21″. The ground area 21″ is fixed with respect to the vehicle 10 position at a specific time. As can be gleaned, as the vehicle 10 travels forward, the vehicle 10 travels over ground area 21″. The image taken on the ground area 21″ effectively becomes an under vehicle image to the vehicle 10. A driver viewing the display unit, displaying the vehicle 10 as shown in FIGS. 5A, 6A, 7A for example, will thus perceive the taken image on the ground area 21″ as the ground under the vehicle 10, at the time when passing the ground area 21″. The actual image was however taken earlier and before passing over the ground area 21″. Hence no under vehicle cameras are necessary. As can further be seen, the charge station 30 is displayed as being underneath the vehicle 10 although slightly displaced a distance corresponding to the vehicle displacement.

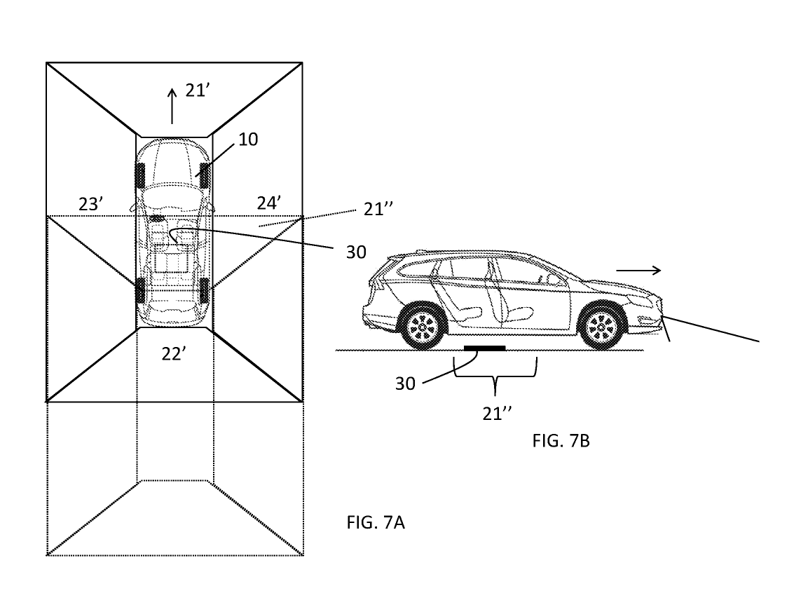

FIGS. 7A-7B show in a similar manner the vehicle 10 after travelling yet another distance. The first ground area 21″ is even further displaced with respect to the vehicle 10 and thus visualizes how the vehicle 10 travels across the ground. The image is thus also visualized displaced in correspondence with how the vehicle 10 is moved, i.e., driven by the driver. As can further be seen, the charge station 30 is displayed as being underneath the vehicle 10 slightly further displaced a distance corresponding to the vehicle displacement. By the assistance of the method a driver may easily position the vehicle 10 with respect to e.g., the charge station 30 even though the vehicle does not have the ability to image directly underneath the vehicle.

The position of the ground which has been imaged is thus tracked so that the image may be visualized as an under vehicle view when a driver drives the vehicle over the specific ground. The tracking may be made purely by calculations or by position measurements, combinations thereof are of course possible.

The method may further comprise the step of incorporating the image in a live stream. The image may thus be stitched with the live stream taken by the cameras of the surrounding view, giving the driver a bird's eye view of the vehicle 10 including an under vehicle view when moving over the specific ground area. In general, the method may thus comprise the step of stitching an image taken at a first time with a second image taken at a second time, and displaying those images at the same time on the display unit. The second image is preferably a live stream. The method may thus comprise to take a still image and stitch that image with a live stream from a camera. The time difference between the first time and the second time is dependent on the vehicle speed.

As an option; a camera, e.g., the front camera, continuously captures an image of e.g., the front field of view 21′ and live stream that image to the display unit. As the vehicle 10 moves, as illustrated in FIGS. 5A-7B, the captured images may be temporarily stored and displayed slightly delayed to display the ground underneath the vehicle as the vehicle travels across the ground area 21″. The time delay is dependent on the vehicle speed.

The surrounding view and the under vehicle view may be superposed onto a contour, silhouette, or other image representing the vehicle. The vehicle is preferably transparent in order to give the driver a proper view of the ground underneath the vehicle, i.e., the under vehicle view.

According to an embodiment, the method may be applied in order to display an object on the ground underneath the vehicle such as a charge station or point, a vehicle hoist, a vehicle maintenance pit, a manhole cover, or the like. Just as a matter of example, a charge station 30 is illustrated in FIGS. 5A-7B. The method may thus be used when positioning the vehicle with respect to an object on the ground, as an image of the ground, in front, rear, or at the sides of the vehicle may be imaged, and subsequently displayed as an under vehicle view of the vehicle when the vehicle passes the ground which has been imaged. In accordance with the method, the image of an object may be displayed, or if the object is recognized using an object recognition unit, only the object may be displayed. This is especially useful as the vehicle may be visualized on the display unit from the side, with the measured or estimated height of object visualized, as shown in FIGS. 5B, 6B, and 7B for example.

The image, whether it is a still image or a temporarily stored stream of images, i.e., a film, is displaced as a function of the vehicle speed. The image may thus be visualized as moving in correlation with how the vehicle moves. In the disclosure above, this was illustrated by moving the vehicle straight ahead. The steering angle is set to 0° and the speed of the vehicle determines the speed at which the image is displaced when displayed on the display unit. As can be gleaned, the same method may be applied independently of how the vehicle moves. The vehicle may of course be turned when moving forward or rearward. Independently of how the vehicle moves, the around view monitoring system can image the surroundings and use the images and display the images or objects on the ground as an under vehicle view, i.e., as an image of the ground underneath the vehicle, when driving over the imaged ground. This will provide a full bird's eye view of the vehicle and what is underneath the vehicle especially if stitched, or in any other way correlated with the live stream provided by the around view monitoring system.

As mentioned, the position of the ground is tracked with respect to the vehicle. The position of the ground which has been imaged may thus be related to the specific image taken on the ground. This can be done by pinpointing the image with a geographical position for example. If a still image is used, each still image, or set of still images, is given a geographical position e.g., set by a GPS unit, preferably an enhanced GPS unit. Optionally, the position of the ground which has been imaged may be related to the vehicle position via the vehicle speed, travelled distance, and as a function of the steering angle and turning radius. Hence, in general the GPS position and/or a calculated position may be used to relate the ground, and thus the image position, of the image with the position of the vehicle. Combinations of both steps are of course possible.

Stored images may be deleted after a predetermined time and/or after the vehicle has driven a pre-set distance. A suitable predetermined time is 5 minutes or less. This will prevent the usage of too old images of the ground, as new objects may have been placed on the ground, or been removed therefrom.

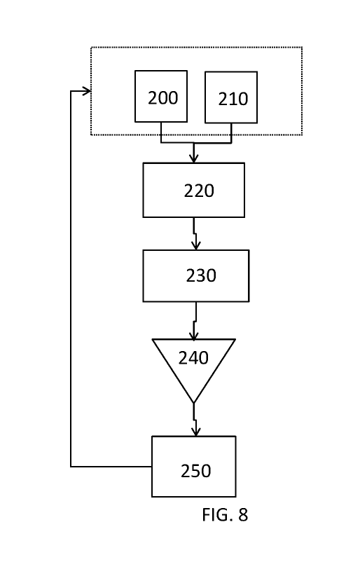

FIG. 8 shows a block diagram of illustrating a non-limiting embodiment of the present disclosure. At step 200, live streams are created using the available cameras in the around view monitoring system. The live stream is visualized on the display unit.

At step 210 one or more cameras of the around view monitoring system are used to create images, i.e., snap shots, of the vehicle surroundings. The cameras are imaging in front of the vehicle, behind the vehicle and on the sides of the vehicle. It should be noted that other cameras may be used than those specifically used for the live streaming.

At step 220 the vehicle moves and the available sensors forward information/data (e.g., the vehicle speed, travelled distance and steering angle) to the processing unit. Other sensors may optionally or additionally be used to correlate the position of the vehicle with respect to the image such as GPS positions.

At step 230 the relative position of the ground which has been imaged by the image and the vehicle is correlated. If the vehicle moves, the image is moved respectively or portrayed as moving with the vehicle. The correlation may be performed by calculating or by measuring the relative positions of the ground which is the subject of the image and the vehicle. If the vehicle speed is zero, the image is still, i.e., not moving. This gives the driver a view of what is underneath the vehicle although the image was taken on the ground when the vehicle was at the side of the imaged ground.

At 240 the image is stitched into the live stream to provide a camera view of what is beneath the vehicle if the vehicle is moved over the ground imaged by the said image.

At 250 the stitched camera view is displayed on the display unit and preferably superposed an image representing the vehicle so at to give the driver a good bird's eye view of the vehicle, the surroundings and the ground underneath the vehicle.

The image stitching may be performed in different ways. Generally an algorithm is used to relate pixel coordinates in one image with pixel coordinates in a second image to align the images. Various pairs, or groups, of images are further aligned. Features in the images such as stones, lane markings etc. on the road, are matched to reduce the time to find correspondence between images. Methods such as image registration and/or key point detection may be used. The images may further be calibrated to harmonize the images. Defects due to exposure differences between images, camera response and chromatic aberrations, vignetting, and distortions may be reduced or removed. Image blending may thereafter be performed. When blending, the calibration step is implemented and usually involves rearranging the images to form an output projection. The purpose is to provide images with no seams, or to minimize the seams between the images. Colors maybe adjusted in the images.

It should be noted that the method disclosed herein, and the arrangement, may be used in combination with cameras positioned underneath vehicle specifically arranged to film underneath the vehicle, for example as a back-up system or verification system.

As one skilled in the art would understand, the processing unit 100, cameras 110, illumination units 115, sensors 120, navigation unit 130, display unit 140, data input unit 150, communication unit 160, memory unit 180, and any other system, unit, or device described herein may individually, collectively, or in any combination comprise appropriate circuitry, such as one or more appropriately programmed processors (e.g., one or more microprocessors including central processing units (CPU)) and associated memory, which may include stored operating system software and/or application software executable by the processor(s) for controlling operation thereof and for performing the particular algorithms represented by the various functions and/or operations described herein, including interaction between and/or cooperation with each other. One or more of such processors, as well as other circuitry and/or hardware, may be included in a single ASIC (Application-Specific Integrated Circuitry), or several processors and various circuitry and/or hardware may be distributed among several separate components, whether individually packaged or assembled into a SoC (System-on-a-Chip).

While exemplary embodiments are described above, it is not intended that these embodiments describe all possible forms according to the disclosure. In that regard, the words used in the specification are words of description rather than limitation, and it is understood that various changes may be made without departing from the spirit and scope of the disclosure. Additionally, the features of various implementing embodiments may be combined to form further embodiments according to the disclosure.

What is claimed is:

1. A method for illustrating ground underneath a vehicle using an around view monitoring system, the around view monitoring system comprising at least one camera, a processing unit and a display unit, the method comprising;
taking at least one image of ground using at least one camera;
tracking position of the ground with respect to the vehicle; and
visualizing the ground as an under vehicle view and as a function of vehicle speed, if the vehicle is moved over at least a portion of the ground.

2. The method according to claim 1 further comprising providing a live stream from at least one camera.

3. The method according to claim 2 wherein the at least one image is stitched with the live stream feed from the at least one camera.

4. The method according to claim 1 further comprising superposing the at least one image on an image representing the vehicle.

5. The method according to claim 1 wherein the at least one image is a still image or a temporarily stored stream.

6. The method according to claim 1 wherein the at least one camera of the around view monitoring system comprises at least a front directed camera, a rear directed camera, a first side camera and a second side camera, and wherein the method comprises taking one or more images by each of at least two of the cameras, and stitching the images to form the at least one image.

7. The method according to claim 1 wherein the at least one image is visualized as a function of at least one additional vehicle parameter.

8. The method according to claim 7 wherein the at least one additional vehicle parameter comprises steering angle and/or travelled distance.

9. The method according to claim 1 wherein the vehicle defines a vehicle periphery on the ground when viewed from above, and the at least one image is taken on the ground outside of the vehicle periphery.

10. The method according to claim 9 whereby the at least one image is stitched with a live stream so as to form a stich seam following the vehicle periphery.

11. The method according to claim 1 wherein the at least one image is visualized as a 3D image.

12. The method according to claim 11 further comprising visualizing a side view of the at least one image on an image representing the vehicle.

13. The method according to claim 1 wherein the at least one image is provided with a selected number of frames per second, the selected number of frames per second being set as a function of the vehicle speed.

14. An around view monitoring system for a vehicle, the around view monitoring system comprising:
at least one camera for taking at least one image of ground; and
a processing unit configured to communicate with the at least one camera;
wherein the processing unit is configured to track a ground area with respect to the vehicle based on the at least one image and to generate a signal for use in visualizing the at least one image as an under vehicle view if the vehicle is moved over at least a portion of the ground area.

15. The monitoring system according to claim 14 further comprising a display unit for displaying the under vehicle view based on the signal output by the processing unit.
